(19) United States
(12) Patent Application Publication
(10) Pub. No.: US 2025/0284532 A1
(43) Pub. Date: Sep. 11, 2025

(54) TASK PROCESSING METHOD

(71) Applicant: CLOUD INTELLIGENCE ASSETS HOLDING (SINGAPORE) PRIVATE LIMITED, Singapore (SG)

(72) Inventor: Dapeng NIE, Hangzhou, Zhejiang (CN)

(21) Appl. No.: 18/859,523

(22) PCT Filed: Apr. 14, 2023
(86) PCT No.: PCT/CN2023/088249

§ 371 Date: Oct. 23, 2024

(30) Foreign Application Priority Data
Apr. 24, 2022 (CN) 202210454886.1

(51) Int. Cl. G06F 9/48; G06F 9/50

(52) U.S. Cl. CPC G06F 9/4856; G06F 9/5044; G06F 9/5083

(57) ABSTRACT

Embodiments of the present specification provide a task processing method including: determining current state information of initial virtual nodes based on a target task received, where the current state information is determined based on a physical computing unit corresponding to the initial virtual nodes; based on task type information of the target task, determining candidate virtual nodes corresponding to the task type information from the initial virtual nodes; and determining a corresponding target virtual node for the target task based on the current state information of the candidate virtual nodes, and executing the target task through the target virtual node, thereby meeting a need to accurately determine the target virtual node for the target task.

### CROSS-REFERENCE TO RELATED APPLICATIONS

The present application is a National Stage of International Application No. PCT/CN2023/088249, filed on Apr. 14, 2023, which claims priority to Chinese Patent Application No. 202210454886.1, filed with China National Intellectual Property Administration on Apr. 24, 2022 and entitled “TASK PROCESSING METHOD”. The two applications are hereby incorporated by reference in their entireties.

### TECHNICAL FIELD

Embodiments of the present application relate to the field of computer technology and, in particular, to task processing method.

### BACKGROUND

With the rapid development of computer technology, proportion of computing tasks implemented based on a computing device is rapidly increasing. For example, in a heterogeneous computing scenario, proportion of heterogeneous computing based on a heterogeneous hardware (such as a Graphics Processing Unit (GPU)) is rapidly increasing, leading to a widespread application in audio and video production, graphic and image processing, artificial intelligence (AI) training, and other fields. As different computing service providers support the execution of heterogeneous computing tasks through computing instances, there arises a need to accurately determine computing instances for different heterogeneous computing tasks based on their workload types. Therefore, there is an urgent need to provide a solution that can meet an elastic scaling requirement for accurately allocating computing instances for heterogeneous computing tasks.

### SUMMARY

In view of this, embodiments of the present specification provide a task processing method. One or more embodiments of the present specification relate to both a task processing apparatus, a computing device, a computer-readable storage medium, and a computer program to address technical deficiencies in the prior art.

According to a first aspect of an embodiment of the present specification, a task processing method is provided, including:
determining current state information of initial virtual nodes based on a target task received, where the current state information is determined based on a physical computing unit corresponding to the initial virtual nodes;
based on task type information of the target task, determining candidate virtual nodes corresponding to the task type information from the initial virtual nodes; and determining a corresponding target virtual node for the target task based on the current state information of the candidate virtual nodes, and executing the target task through the target virtual node.

According to a second aspect of an embodiment of the present specification, a task processing apparatus is provided, including:
a receiving module, configured to determine current state information of initial virtual nodes based on a target task received, where the current state information is determined based on a physical computing unit corresponding to the initial virtual nodes;
a determining module, configured to, based on task type information of the target task, determine candidate virtual nodes corresponding to the task type information from the initial virtual nodes; and
an executing module, configured to determine a corresponding target virtual node for the target task based on the current state information of the candidate virtual nodes, and execute the target task through the target virtual node.

According to a third aspect of an embodiment of the present specification, a computing device is provided, including:
a memory and a processor;
the memory is configured to store computer-executable instructions; and the processor is configured to execute the executable the computer-executable instructions, when the computer-executable instructions are executed by the processor, the steps of the task processing method described are implemented.

According to a fourth aspect of an embodiment of the present specification, a computer-readable storage medium is provided, which stores computer-executable instructions, when the computer-executable instructions are executed by a processor, the steps of the task processing method described are implemented.

According to a fifth aspect of an embodiment of the present specification, a computer program is provided, when the computer program is executed in a computer, the computer is caused to execute the steps of the task processing method described.

The present specification provides a task processing method including: determining current state information of initial virtual nodes based on a target task received, where the current state information is determined based on a physical computing unit corresponding to the initial virtual nodes; based on task type information of the target task, determining candidate virtual nodes corresponding to the task type information from the initial virtual nodes; and determining a corresponding target virtual node for the target task based on the current state information of the candidate virtual nodes, and executing the target task through the target virtual node.

Specifically, the method determines a corresponding target virtual node for a target task based on current status information of initial virtual nodes and task type information of the target task when the target task is received, and executes the target task through the target virtual node, thereby meeting a need to accurately determine the target virtual node for the target task.

### BRIEF DESCRIPTION OF DRAWINGS

FIG. 1 is a schematic diagram of a Serverless platform scheduling framework provided by the present specification;

FIG. 2 is a schematic diagram of a Serverless scheduling algorithm based on a request concurrency provided by the present specification.

FIG. 3 is a flowchart of a task processing method provided by an embodiment of the present specification.

FIG. 4 is a flowchart of task scheduling in a task processing method provided by an embodiment of the present specification.

FIG. 5 is a schematic diagram of elastic scaling in a task processing method provided by an embodiment of the present specification.

FIG. 6 is a process flowchart of a task processing method provided by an embodiment of the present specification.

FIG. 7 is a structure schematic diagram of a task processing apparatus provided by an embodiment of the present specification.

FIG. 8 is a structure block diagram of a computing device provided by an embodiment of the present specification.

### DESCRIPTION OF EMBODIMENTS

The following description provides numerous specific details to enhance comprehension of the present specification. However, the present specification is capable of being implemented in many other manners different from those described herein. Those skilled in the art can make similar generalizations without deviating from the essence of the present specification, and thus the scope of the present specification is not limited by specific embodiments disclosed below.

The terms used in one or more embodiments of the present specification are for a purpose of describing the specific embodiments only and are not intended to limit the one or more embodiments of the present specification. As used in one or more embodiments of the present specification and the appended claims, the singular forms “a”, “an”, “the”, and “this” are intended to include the plural forms as well, unless the context clearly indicates otherwise. It should also be understood that the term “and/or” used in one or more embodiments of the present specification refers to and includes any or all possible combinations of one or more of the associated listed items.

It should be understood that although the terms first, second, third, etc. may be used to describe various information in one or more embodiments of the present specification, the information should not be limited to these terms. These terms are used only to distinguish information of the same type from one another. For example, without departing from the scope of one or more embodiments of the present specification, first information may also be referred to as second information, and similarly, second information may also be referred to as first information. The word “if” as used herein may be interpreted as “at the time of . . . ” or “when the . . . ” or “in response to determining” depending on the context.

Firstly, the terms involved in one or more embodiments of this specification are explained.

GPU: generally refers to a graphics processing unit. The graphics processing unit (graphics processing unit, Abbreviation: GPU), also known as a display core, a visual processor, a display chip, is a microprocessor specially used to perform image and graphics related calculations on a personal computer, a workstation, a game console and some mobile devices (such as a tablet PC, a smart phone, etc.).

VPU: VPU (Video Processing Unit, Video Processing Unit) is a new core engine of a video processing platform, which has a function of hard decoding and an ability to reduce the load of CPU (central processing unit). In addition, VPU can reduce server load and network bandwidth consumption. Used to distinguish from graph processing unit (GPU). The graphics processing unit also includes three main modules: a video processing unit, an external video module and a post-processing module.

TPU: a processor for neural network training, mainly used for a deep learning and an AI (artificial intelligence) computing. TPU has programming like GPU and CPU, and a set of CISC instruction sets (Complex Instruction Set). As a machine learning processing unit, it not only supports a certain type of neural network, but also supports a convolutional neural network, a LSTM (long short-term memory artificial neural network), a fully connected network and many more. The TPU uses a low-precision (8-bits) calculation to reduce a number of transistors used per operation.

GPGPU: general-purpose computing on graphics processing units (General-purpose computing on graphics processing units, GPGPU) is a graphics processing unit that utilizes graphics processing tasks to compute general-purpose computing tasks originally handled by a central processing unit. These general-purpose computations often have nothing to do with graphics processing. Due to a powerful parallel processing capability and a programmable pipeline of a modern graphics processing unit, stream processing unit can process non-graphics data. Especially when faced with Single Instruction Multiple Data (SIMD) and the amount of data processing operations is much greater than the need for data scheduling and transmission, the general-purpose graphics processing units greatly outperform central processor application.

Hardware encoder: a video encoding unit built into a graphics card.

Hardware decoder: a video decoding unit built into a graphics card.

SP (Streaming Processor, Stream Processing Units): stream processor directly maps a multimedia graphic data stream to the stream processor for processing. There are two types: programmable and non-programmable.

CUDA Core: a stream processor.

Tensor Core: a specialized execution unit designed to perform tensor or matrix operations.

NVLINK: a bus and its communication protocol. NVLink uses a point-to-point structure and serial transmission to connect a central processing unit (CPU) and a graphics processing unit (GPU). It can also be used to connect multiple GPUs.

GPU instance: a type of container that can run GPU tasks.

Serverless platform: a serverless computing platform, or a microservice platform.

RR polling: RR polling scheduling means that in one polling response request, each request signal will receive a response.

With the continuous development of computer technology, on the one hand, proportion of GPU-based heterogeneous computing is rapidly increasing. For example, GPUs are widely used in audio and video production, graphics and image processing. AI training, AI reasoning, rendering scenarios and other fields to achieve an acceleration ratio several times or even tens of thousands of times compared to CPUS. On the other hand, based on a popularization of cloud computing and a continuous upward movement of computing interface, more and more customers are migrating from VMs (virtual machines) and containers to Serverless elastic computing platforms, allowing customers to focus on their own computing tasks and shielding many details of non-computing tasks themselves, such as cluster management, observability, and diagnosis, etc.

As a Serverless platform supports GPU heterogeneous computing tasks, an elastic scaling requirement based on workload types of different heterogeneous computing tasks naturally arises. That is, heterogeneous computing tasks, based on GPU hardware, will use different hardware computing units built into a GPU according to different types of workloads. For example: the audio and video production will use a hardware encoding unit/hardware decoding unit of the GPU, a high-precision AI training task will use a TensorCore computing unit of the GPU, and a low-precision AI reasoning task will use a CUDA Core computing unit of the GPU. Heterogeneous computing tasks based on a Serverless platform require the Serverless platform to provide a method that allows customers of the Serverless platform can select appropriate GPU indicators based on their heterogeneous computing workload types, thereby coping with an elastic expansion during a peak flow period and an elastic reduction during a low flow period.

Based on this, in an elastic scaling solution provided by the present specification, a Serverless platform usually elastically scales a GPU computing instance based on request concurrency. For example, when function concurrency is set to 1, 100 concurrencies (i.e., 100 concurrent requests) will create 100 GPU instances; when the function concurrency is set to 10, 100 concurrencies will create 10 GPU instances. This elastic scaling method based on request concurrency does not truly reflect whether GPU hardware is fully utilized. For example, when the function concurrency is set to 10, 100 concurrencies create 10 GPU instances, and each GPU instance has different hardware components inside the GPU, such as a GPU computing unit, a GPU storage unit, and a GPU interconnection bandwidth resource. The utilization rate of each GPU component may still remain at a low level, resulting in a waste of resource and cost.

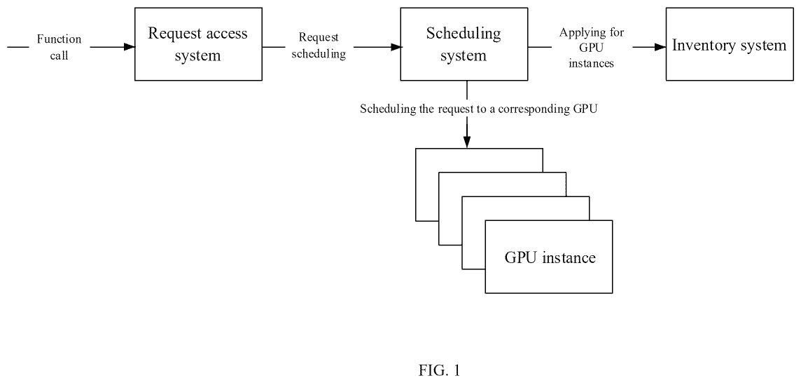

Further, refer to FIG. 1, FIG. 1 is a schematic diagram of a Serverless platform scheduling framework provided by the present specification, the scheduling framework includes a request access system, a scheduling system, an inventory system, and GPU instances. When a user completes a Serverless service function writing, a function call request will be initiated to the request access system of a Serverless platform. Refer to FIG. 1, FIG. 1 describes processing flow after the function call request arriving at the Serverless platform, specifically including: the request access system provides hypertext transfer protocol (HTTP), hypertext transfer protocol secure (HTTPS) or other access protocols, and schedules the request to the scheduling system through the access protocols; the scheduling system is responsible for applying for GPU instances from the inventory system, and is responsible for scheduling the function call request of the user to different GPU instances to run corresponding functions. The inventory system is responsible for managing GPU instances. When the scheduling system detects that a current GPU instance cannot service the function call request, it requests a new GPU instance from the inventory system, and the inventory system creates a GPU instance based on a request of the scheduling system. The GPU instance is responsible for a specific execution of a function.

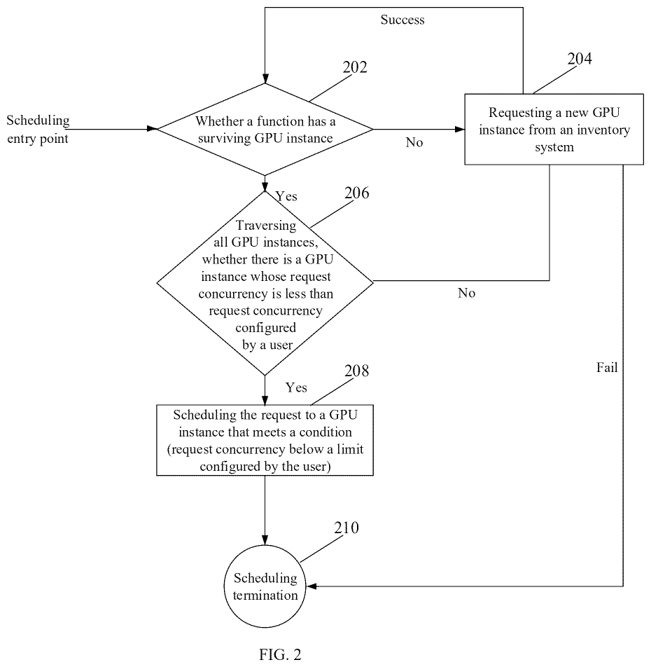

Based on this, refer to FIG. 2, FIG. 2 is a schematic diagram of a Serverless scheduling algorithm based on a request concurrency provided by the present specification. The scheduling method is based on the above Serverless platform scheduling framework provided in FIG. 1, and specifically includes the following steps.

Step 202, determining a function call request has a surviving GPU instance for.

Specifically, a Serverless platform can provide a scheduling entry point to a user. When the user initiates the function call request to the Serverless platform through the scheduling entry point, the Serverless platform determines whether the function call request has a corresponding surviving GPU instance, and then schedules the function call request to the GPU instance.

If yes, executing step 206, if no, executing step 204.

Step 204, applying for a new GPU instance from an inventory system.

Specifically, the Serverless platform requests the new GPU instance from the inventory system. If the request is successful, requesting to obtain a surviving GPU instance and executing step 202, and if the request fails, executing step 210.

Step 206, traversing all GPU instances and determining whether there is a GPU instance whose request concurrency is less than request concurrency configured by the user.

Specifically, after determining that the function call request has a surviving GPU instance, the Serverless platform traverses all GPU instances and determines whether there is a GPU instance whose request concurrency is less than the request concurrency configured by the user. If yes, executing step 208; if no, executing step 204.

Step 208, scheduling the function call request to a GPU instance that meets a condition.

Specifically, the Serverless platform schedules the function call request to a GPU instance that meets the condition.

Step 210, scheduling termination.

Based on this, the elastic scaling scheduling method that is acquiescent of the Serverless platform based on the request concurrency, although it realizes the scheduling of the request, does not comprehensively consider the utilization rate of various components inside the GPU hardware. This will result in elastic expansion triggered by request concurrency being higher than a user setting when the utilization rate of various components inside the GPU hardware is maintained at a low level, leading to a cost waste for the user. In addition, when the utilization rate of various components within the GPU hardware is maintained at a high level, elastic scaling triggered by request concurrency being lower than the user setting causes a performance loss to the user.

In summary, the elastic scaling scheduling method that is acquiescent of the Serverless platform based on the request concurrency does not take into account the utilization rate of various components inside the GPU hardware, resulting in cost and performance losses.

Based on the defects existing in the above-mentioned scheme, the present specification provides a task processing method, which proposes a system structure for elastic scaling of heterogeneous computing tasks on a Serverless platform, thereby solving performance and cost issues caused by the elastic scaling of Serverless heterogeneous hardware.

Specifically, in the present specification, a task processing method is provided. The present specification also involves a task processing apparatus, a computing device, a computer-readable storage medium and a computer program, which are described in detail one by one in the following embodiments.

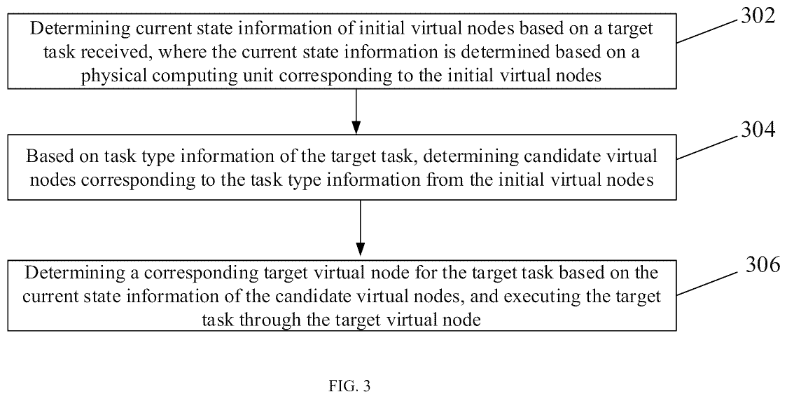

FIG. 3 is a flowchart of a task processing method provided by an embodiment of the present specification, which specifically includes the following steps.

Step 302, determining current state information of initial virtual nodes based on a target task received, where the current state information is determined based on a physical computing unit corresponding to the initial virtual nodes.

The target task can be understood as a heterogeneous computing task that requires processing of a heterogeneous hardware device. For example, the heterogeneous computing task includes but is not limited to an audio and video production task, a graphics and image processing task, an AI training task, an AI reasoning task, a scene rendering task, etc.

The initial virtual nodes can be understood as nodes that can run the heterogeneous computing task. For example, the initial virtual nodes can be general computing nodes, GPU instances, virtual machines, containers, etc.

The physical computing unit can be understood as a physical device that supports an implementation of the initial virtual nodes. For example, the physical computing unit can be a GPU, a GPGPU, a VPU, a TPU, etc.

In a case where the initial virtual nodes are GPU instances, the current state information can be understood as a utilization rate of each hardware component in a GPU corresponding to the GPU instances. It should be noted that the task processing method provided in the present specification can be applied to a Serverless platform or a scheduling system in the Serverless platform. The scheduling system can be understood as a system that schedules the target task to a corresponding GPU instance.

Specifically, after receiving the target task, the scheduling system can determine the current state information of all initial virtual nodes based on the target task received, where the current state information of the initial virtual nodes is determined based on the physical computing unit corresponding to the initial virtual nodes.

In actual applications, in a case where the initial virtual nodes are GPU instances and the physical computing unit is a GPU, the current state information of the initial virtual nodes being determined based on the physical computing unit corresponding to the initial virtual nodes can be understood as determining a utilization rate index of each hardware component inside a GPU hardware as a current utilization rate of the GPU instance corresponding to each hardware component, so as to facilitate subsequent task scheduling based on the utilization rate. A specific implementation method is as follows.

The determining the current state information of the initial virtual nodes based on the target task received includes:
based on the target task received, determining physical computing subunits in the physical computing unit and current operation information of the physical computing subunits;
determining a target physical computing subunit corresponding to the initial virtual nodes from the physical computing subunits;
using the current operation information of the target physical computing subunit as the current state information of the initial virtual nodes.

The physical computing subunits can be understood as various hardware components inside GPU hardware, including but not limited to a hardware encoder, a hardware decoder, a SP, a CUDA Core, a Tensor Core, etc. The current operation information of the physical computing subunits can be understood as a utilization rate index of each hardware component. Based on this, the scheduling system determines the current operation information of each physical computing subunit in the physical computing unit, and can use the current operation information as the current state information of the initial virtual nodes. For example, the scheduling system can obtain the utilization rate index of each component inside the GPU hardware, and determine the utilization rate index as a utilization rate corresponding to the GPU instances.

The target physical computing subunit corresponding to the initial virtual nodes can be understood as hardware devices in the GPU corresponding to the GPU instances.

The following takes an application of a task processing method provided in the present specification in a Serverless scenario as an example to further explain the determination of the current state information of the initial virtual nodes based on the physical computing unit, where the physical computing unit is a GPU, the target task is a graphics and image processing task, and the target physical computing subunit is a hardware encoder and a hardware decoder.

Based on this, in a case that the scheduling system of the Serverless platform receives the target task, it determines a current utilization rate of each hardware unit in the GPU, and determines a hardware unit corresponding to a GPU instance from multiple hardware units. A GPU instance of the graphics and image processing task corresponds to a hardware encoder and a hardware decoder. A GPU instance of an AI reasoning processing task corresponds to a CUDA Core and a Tensor Core. The current utilization rate of each hardware unit in the GPU is used as the utilization rate of the corresponding GPU instances.

In embodiments of the present specification, in a case that the target task is received, the current state information of the initial virtual nodes is determined based on the current operation information of the physical computing subunits in the physical computing unit, so as to facilitate a subsequent determination of the corresponding target virtual node for the target task based on the utilization rate.

Further, in an embodiment provided in the present specification, before determining the current state information of the initial virtual nodes based on the target task received, the method further includes:
receiving the current operation information of the physical computing subunits in the physical computing unit sent by an information collection module, where the information collection module is a module configured to monitor the current operation information of the physical computing subunits in the physical computing unit.

The information collection module may be understood as any module that realizes a function of collecting the current operation information of the physical computing unit, such as a GPU monitor.

Specifically, the information collection module can monitor the current operation information of each physical computing subunit in the physical computing unit in real time, and send the current operation information to the scheduling system. Therefore, the scheduling system can receive the current operation information of each physical computing subunit in the physical computing unit sent by the information collection module. For example, the GPU monitor can obtain the utilization rate index of each hardware component inside the GPU corresponding to each GPU instance, and periodically synchronize the utilization rate index to the scheduling system.

In embodiments of the present specification, that is to say, the current operation information of the physical computing unit sent by the information collection module can be received, so that the current state information of the initial virtual nodes can be determined based on the current operation information, where the current operation information of the physical computing unit may be current operation information of each physical computing subunit in the physical computing unit.

Further, in an embodiment provided in the present specification, the physical computing unit is a GPU.

Accordingly, the determining current state information of the initial virtual nodes based on the target task received includes:
based on the target task received, determining hardware components of the GPU and a current utilization rate of the hardware components; and
determining a target hardware component corresponding to the initial virtual nodes from the hardware components, and using the current utilization rate of the target hardware component as the current state information of the initial virtual nodes.

The hardware components of the GPU include but are not limited to a hardware encoder, a hardware decoder, a SP, a CUDA Core, a Tensor Core, etc.

Continuing with the above example, the GPU monitor can obtain the utilization rate index of each hardware component inside the GPU corresponding to each GPU instance, and periodically synchronize the utilization rate index to the scheduling system. After that, in a case that the scheduling system of the Serverless platform receives the target task, it determines the current utilization rate of each hardware unit in the GPU, and determines the hardware units corresponding to the GPU instance from multiple hardware units, and uses the current utilization rate of each hardware unit in the GPU as the utilization rate of the corresponding GPU instance. This makes it easier to determine the corresponding GPU instance for the target task based on the utilization rate.

Step 304: based on task type information of the target task, determining candidate virtual nodes corresponding to the task type information from the initial virtual nodes.

The task type information of the target task may be understood as information characterizing the type of the target task, such as a character, a number, and other information. When the target task is an AI training task, task type information of the target task may be information such as a character and a number representing a type of the AI training task.

The candidate virtual nodes can be understood as all virtual nodes in the initial virtual nodes that can process the target task. For example, in a case that the target task is a graphics and image processing task, the candidate virtual nodes are GPU instances capable of processing the graphics and image processing task, where the GPU instances processing the graphics and image processing task correspond to a hardware encoder and a hardware decoder in the GPU.

Specifically, after determining the current state information of the initial virtual nodes, the scheduling system can determine the task type information of the target task, and based on the task type information, determine the candidate virtual nodes corresponding to the task type information from the initial virtual nodes, that is, all virtual nodes in the initial virtual nodes that can process the target task.

Step 306: determining a corresponding target virtual node for the target task based on the current state information of the candidate virtual nodes, and executing the target task through the target virtual node.

The target virtual node may be understood as a GPU instance to which a heterogeneous computing task needs to be scheduled.

Specifically, the scheduling system can add or select the corresponding target virtual node for the target task based on the current state information of the candidate virtual nodes, and execute the target task through the target virtual node.

In an embodiment provided in the present specification, a corresponding GPU instance can be added for a heterogeneous computing task by expanding the capacity of GPU instances; or a GPU instance with better hardware performance can be selected for the heterogeneous computing task from currently existing GPU instances, thereby achieving flexible scheduling of the heterogeneous computing task and saving hardware resource. Based on this, a method of expanding the capacity of GPU instances for the heterogeneous computing task is as follows.

The determining the corresponding target virtual node for the target task based on the current state information of the candidate virtual nodes includes:
based on the current state information of the candidate virtual nodes, adding the corresponding target virtual node for the target task.

Specifically, after determining the candidate virtual nodes, in a case that the scheduling system, based on the current status information of the candidate virtual nodes, determines that one or more candidate virtual nodes cannot process the target task, the scheduling system re-adds the corresponding target virtual node for the target task, that is, re-requests or creates a virtual node for the target task.

Further, in embodiments provided in the present specification, the based on the current state information of the candidate virtual nodes, adding the corresponding target virtual node for the target task includes:
determining a target computing ratio of the candidate virtual nodes based on the current state information of the candidate virtual nodes; and
in a case that the target calculation ratio is greater than or equal to a first ratio threshold, adding the corresponding target virtual node for the target task.

In a case that the current state information is a utilization rate of a hardware encoding unit, the target calculation ratio can be understood as a utilization rate of a subsequent virtual node. The utilization rate can be set according to an actual application scenario, for example, the utilization rate can be any value in a range of 0% to 100%, or any value in a range of [0,1], etc.

The first ratio threshold can be set according to an actual application scenario, which is not specifically limited in the present specification, for example, 70%, 0.7, etc.

Continuing with the above example, the target task may be an audio and video production task, the current state information is the utilization rate of the hardware encoding unit, and the first ratio threshold may be 70%. Based on this, the scheduling system determines a utilization rate of a hardware decoding unit corresponding to a GPU instance, and uses the utilization rate of the hardware decoding unit as a utilization rate of the GPU instance corresponding to the hardware decoding unit, where the utilization rate may be 80%. Then, in a case that the scheduling system determines that the utilization rate is greater than the first ratio threshold (70%), it determines that the remaining computing capacity of the GPU instance is too low and may not be able to execute the current audio and video production task. Therefore, a new GPU instance is created for the audio and video production task by expanding the capacity of the GPU instance, thereby ensuring a normal execution of the audio and video production task.

In embodiments provided in the present specification, the scheduling system can achieve a purpose of expanding the capacity of the GPU instance by applying for a GPU instance from an inventory system, thereby further ensuring a normal execution of the heterogeneous computing task. The specific implementation method is as follows.

The adding the corresponding target virtual node for the target task includes:
generating a virtual node acquiring request based on the target task, and sending the virtual node acquiring request to a virtual node providing module; and
receiving a to-be-determined virtual node sent by the virtual node providing module based on the virtual node acquiring request, and determining the to-be-determined virtual node as the target virtual node corresponding to the target task.

The virtual node providing module may be understood as a module that can provide a virtual node for the target task, for example, an inventory system in Serverless. Accordingly, the to-be-determined virtual node may be understood as a virtual node provided by the inventory system. For example, a newly created GPU instance of the inventory system.

Continuing with the above example, in a case that the scheduling system determines that the utilization rate of the existing GPU instance is insufficient to run the audio and video production task, it can send a GPU instance acquiring request to the inventory system to request a new GPU instance. The inventory system will create a new GPU instance for the scheduling system based on the request of the scheduling system and send the new GPU instance to the scheduling system. The scheduling system uses the newly applied GPU instance as a GPU instance for processing the audio and video production task. Subsequently, the scheduling system can schedule the audio and video production task to run on the new GPU instance.

Further, the scheduling system matches a GPU instance with better hardware performance for the heterogeneous computing task from the currently existing GPU instances in the following manner.

The determining the corresponding target virtual node for the target task based on the current state information of the candidate virtual nodes includes:
based on the current state information of the candidate virtual nodes, selecting the target virtual node corresponding to the target task from the candidate virtual nodes.

Specifically, after determining the candidate virtual nodes, the scheduling system can select the corresponding target virtual node for the target task from the candidate virtual nodes when it is determined that the one or more candidate virtual nodes can process the target task based on the current state information of the candidate virtual nodes.

Further, in embodiments provided in the present specification, the based on the current state information of the candidate virtual nodes, selecting the target virtual node corresponding to the target task from the candidate virtual nodes includes:
determining a target computing ratio of the candidate virtual nodes based on the current state information of the candidate virtual nodes;
in a case that the target calculation ratio is less than a first ratio threshold, determining a minimum target calculation ratio from the target calculation ratio; and
based on the candidate virtual nodes corresponding to the minimum target calculation ratio, determining the target virtual node corresponding to the target task.

Continuing with the above example, the scheduling system determines the utilization of one or more hardware decoding units corresponding to the GPU instance. In a case that the utilization rate is determined less than or equal to the first ratio threshold of 70%, it is determined that there is a GPU instance in the current GPU instances that can run the audio and video production task. The scheduling system then determines a minimum utilization rate from the utilization rate that is less than or equal to the first ratio threshold of 70%.

In a case where there is one minimum utilization rate, the GPU instance corresponding to the minimum utilization is determined as a GPU instance for running the audio and video production task.

In the case where there are multiple minimum utilization rates, one or more GPU instances are randomly determined from the GPU instances corresponding to the multiple minimum utilization rates as the GPU instances for running the audio and video production task.

In practical applications, in a case that it is determined that the utilization rate is less than or equal to the first ratio threshold of 70%, determining the GPU instance with better performance further includes:
sorting the candidate virtual nodes based on the target computing ratio to obtain a sorting result of the candidate virtual nodes, where the candidate virtual nodes include at least two;
determining a corresponding target virtual node for the target task from the candidate virtual nodes based on the sorting result.

Continuing with the above example, in a case that it is determined that the utilization rate is less than or equal to the first ratio threshold of 70%, the scheduling system determines the GPU instances whose utilization rate is less than or equal to the first ratio threshold of 70%, and sorts the GPU instances in a descending order based on the utilization rate to obtain the sorting result of the GPU instances, where the closer the GPU instance is to the front in the sorting result, the lower the utilization rate, that is, the better the performance of the GPU instance. Based on this, the scheduling system schedules the audio and video production task to the first place in the sorting result, or the first specific number of GPU instances in the sorting result, where the specific number can be set according to an actual application scenario, such as the top three or the top ten.

Further, in embodiments provided in the present specification, the physical computing unit is a GPU. In this case, after the executing the target task through the target virtual node, the method further includes:
in a case that it is determined, based on the current utilization rate of the target hardware component, that the target task has been completed, deleting the target virtual node.

Specifically, the scheduling system can monitor the current utilization rate of the target hardware component in real time. For example, the utilization rate index of each hardware component inside the GPU can be obtained through a GPU monitor component (GPU Monitor), and a virtual machine node to be deleted is deleted when it is determined that the target task has been completed based on the utilization rate index, thereby saving hardware resource.

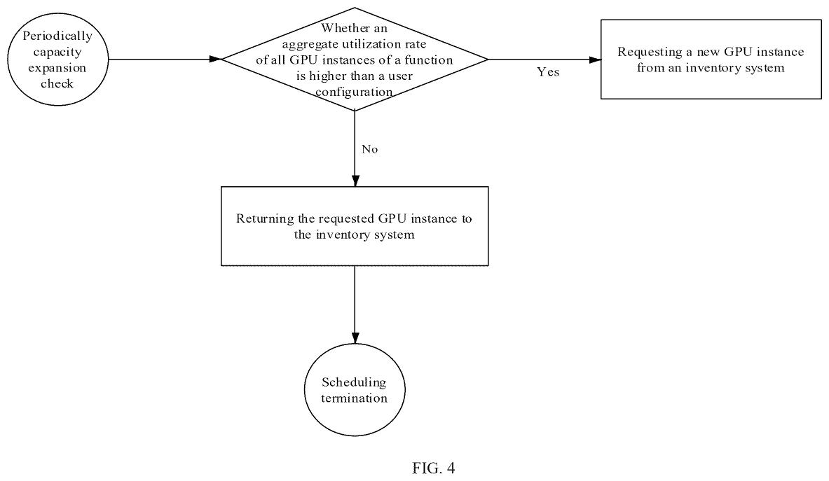

In addition, refer to FIG. 4, FIG. 4 is a flowchart of task scheduling in a task processing method provided by an embodiment of the present specification. A function call request can be understood as the above target task. Based on this, after receiving an instruction request scheduling, a scheduling system can determine whether the function call request has a surviving GPU instance, that is, whether there is an instance that can run the function call request. The method of determining whether there is an instance that can run the function call request can be determined by judging whether the utilization rate of a GPU instance is less than a first ratio threshold (i.e., a preset maximum utilization rate of the GPU hardware).

If not, the scheduling system requests a new GPU instance from an inventory system, and continues to determine whether there is an instance that can run the function call request after the request is successful.

If yes, the scheduling system determines that there is a GPU instance that can run the function call request, and balances load of the function call request to all GPU instances through RR polling, thereby executing scheduling termination. The function call request is load balanced to all GPU instances, which can adapt the above method of sorting the GPU instances based on the utilization rate to determine the GPU instance with better performance to achieve load balancing.

Based on this, when the function call request arrives, the Serverless scheduling system uses RR polling to load balance the request to each GPU instance after expansion or reduction in capacity, thereby ensuring that an entire GPU cluster is fully utilized.

In an embodiment provided in the present specification, the task processing method provided in the present specification can sample the utilization rate of each component inside the GPU hardware and allow a user to set different elastic scaling indexes according to heterogeneous computing tasks in different scenarios, thereby solving the cost waste caused by excessive expansion and the performance loss caused by premature narrowing.

In embodiments provided in the present specification, the elastic scaling scheduling method that is acquiescent of Serverless based on the request concurrency does not take into account the utilization rate of various components inside the GPU hardware, and thus cannot solve the cost waste caused by over-expansion and the performance loss caused by premature narrowing. The task processing method provided in the present specification can sample the utilization rate of the various components inside the GPU hardware and allow the user to set different elastic scaling indexes according to the heterogeneous computing tasks in different scenarios, thereby periodically elastically scaling a GPU instance based on the hardware utilization rate of the GPU instance, solving the cost waste caused by over-expansion and the performance loss caused by premature narrowing. The specific implementation method is as follows.

The task processing method further includes:
determining the current state information of the initial virtual nodes based on the physical computing unit corresponding to the initial virtual nodes; and
in a case that it is determined, based on the current state information, that the initial virtual nodes meet a preset node adding condition, adding a new virtual node; or
in a case that it is determined, based on the current state information, that the initial virtual nodes meet a preset node deletion condition, deleting an idle virtual node in the initial virtual nodes.

Specifically, the scheduling system can periodically determine the physical computing unit corresponding to the initial virtual nodes, and determine the current state information of the initial virtual nodes based on the physical computing unit. For example, a utilization rate of each hardware component in a GPU is monitored in real time, and based on the utilization rate of each hardware component, a utilization rate of a GPU instance corresponding to each hardware component is determined.

Then, in a case that it is determined, based on the current state information, that the initial virtual nodes meet the preset node adding condition, it can be determined that the number of the current initial virtual nodes is too small, and thus a new virtual node is added; or
in a case that it is determined, based on the current state information, that the initial virtual nodes meet the preset node deletion condition, it is determined that the number of the initial virtual nodes is too large and the utilization rate of many virtual nodes is low, so the idle virtual node in the initial virtual nodes are deleted. Virtual nodes can be added and deleted flexibly and accurately, solving the cost waste caused by excessive expansion and the performance loss caused by premature narrowing.

Further, in embodiments provided in the present specification, in the case that it is determined, based on the current state information, that the initial virtual nodes meet the preset node adding condition, adding the new virtual node includes:
determining a target computing ratio of the initial virtual nodes based on the current state information of the initial virtual nodes;
in a case that the target calculation ratio is greater than a node load threshold, determining that the initial virtual nodes meet the preset node adding condition; and
in a case that the initial virtual nodes meet the preset node adding condition, adding the new virtual node based on a virtual node providing module.

The node load threshold may be understood as a threshold that is preset for each initial virtual node and indicates that its utilization rate has reached a load state or is about to reach a load state. In addition, the node load threshold can be set according to an actual application scenario. For example, the node load threshold can be set to 80%.

Specifically, the scheduling system can determine the target computing ratio of the initial virtual nodes based on the current state information of the initial virtual nodes, and in the case that it is determined that the target computing ratio is greater than the node load threshold, determine that the initial virtual nodes meet the preset node adding condition, and in the case that the initial virtual nodes meet the preset node adding condition, request to add the new virtual node from the virtual node providing module, thereby using the virtual node provided by the virtual node providing module as the newly added virtual node.

Continuing with the above example, the task processing method provided in the present specification can allow a user to set different elasticity indexes according to heterogeneous computing tasks in different scenarios. The elasticity indexes include an elastic expansion index and an elastic contraction index. The elastic expansion index can be understood as a utilization rate threshold, which is also the node load threshold. Based on this, after the scheduling system schedules the audio and video production task to the GPU instance with better performance, it can monitor the utilization rate of the GPU instance determined by the hardware decoding unit in real time. In a case that the utilization rate is greater than or equal to the elastic expansion index (the node load threshold) set by the user, the scheduling system can actively request a new GPU instance from the inventory system, and run the audio and video production task together based on the new GPU instance and a GPU instance determined for the audio and video production task based on the utilization rate, thereby ensuring a normal operation of the audio and video production task. It also enables the user to set different elastic scaling indexes based on heterogeneous computing tasks in different scenarios.

Further, in embodiments provided in the present specification, in the case that it is determined, based on the current state information, that the initial virtual nodes meet the preset node deletion condition, deleting the idle virtual node in the initial virtual nodes includes:
determining a target computing ratio of the initial virtual nodes based on the current state information of the initial virtual nodes;
in a case that the target computing ratio is less than a node idle threshold,
determining that the initial virtual nodes meet the preset node deletion condition; and
in a case that the initial virtual nodes meet the preset node deletion condition, deleting the idle virtual node in the initial virtual nodes.

The node idle threshold may be understood as a threshold preset for each initial virtual node and indicates that its utilization rate has reached the node idle threshold. In addition, the node idle threshold can be set according to an actual application scenario. For example, the node load threshold can be set to 0% or 5%.

Continuing with the above example, the task processing method provided in the present specification allows the scheduling system to monitor the utilization rate of the hardware decoding unit in the GPU instance in real time after scheduling the audio and video production task to the GPU instance with better performance. In a case that the utilization rate is less than the elastic shrinkage index (the node idle threshold) set by the user, the scheduling system can proactively delete redundant GPU instances from the inventory system, thereby ensuring a normal operation of the audio and video production task and saving hardware resource.

In actual applications, when deleting the GPU instance, since the audio and video production task may still be running in the GPU instance, the scheduling system needs to delete the GPU instance when the task corresponding to the GPU instance is completed. The specific method is as follows.

The deleting the idle virtual node in the initial virtual nodes includes:
monitoring task execution state information of the idle virtual node; and
in a case that it is determined, based on the task execution status information that the target task is completed, deleting the idle virtual node.

The task execution state information may be understood as information representing the progress of task execution.

Specifically, the scheduling system can monitor the task execution state information of the idle virtual node in real time, and delete the idle virtual node when it is determined, based on the task execution state information, that the target task is completed, thereby saving hardware resource.

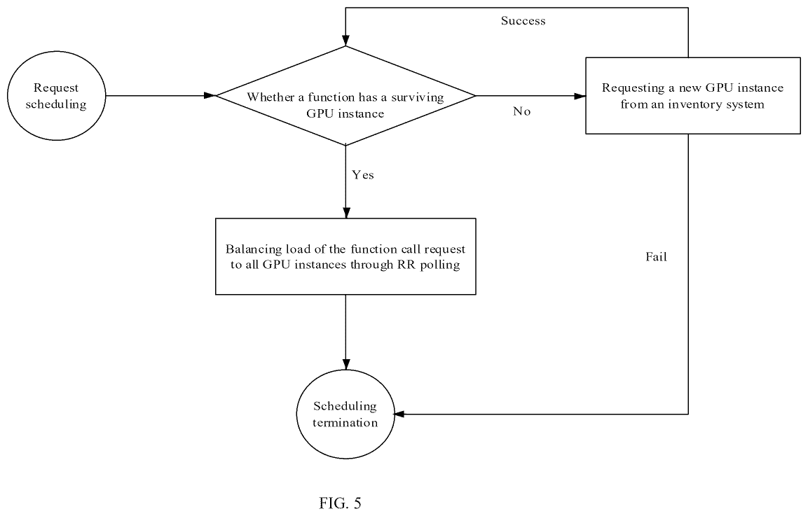

In actual applications, the scheduling system can periodically perform a capacity expansion check. The capacity expansion check can be understood as content in the above embodiment in which the scheduling system performs elastic scaling according to different elastic indexes set by the user for the heterogeneous computing tasks in different scenarios. Refer to FIG. 5, FIG. 5 is a schematic diagram of elastic scaling in a task processing method provided by an embodiment of the present specification, where the elastic scaling is implemented based on the GPU utilization rate, and the user can configure the GPU elastic scaling index of each function. Refer to FIG. 5, the scheduling system can periodically perform the capacity expansion check to determine whether an aggregate utilization rate of all GPU instances of the function (i.e., function call request) is higher than the user configuration, that is, to determine whether the aggregate utilization rate of all GPUs running the function call request is higher than the GPU elastic scaling index configured by the user for each function call request. For example, in an audio and video scenario, the GPU elastic scaling index can be configured to expand the capacity when the hardware encoding utilization rate of the GPU instance is greater than 80%. In an AI scenario, the GPU elastic scaling index can be configured to shrink the capacity when a CUDA CORE hardware utilization rate of the GPU instance is less than 20%.

Based on this, if yes, that is, in a case that the scheduling system determines that the aggregate utilization is higher than the user configuration, it will request a new GPU instance from the inventory system and execute scheduling termination. If not, that is, in a case that the scheduling system determines that the aggregate utilization is lower than the user configuration, it returns the requested GPU instance to the inventory system and executes scheduling termination.

It should be noted that when the task processing method is applied in a Serverless scenario, for an elastic scaling problem of GPU-based heterogeneous computing task, the current state information can also include multi-dimensional mixed indexes, so as to facilitate a subsequent comprehensive scheduling decision based on multi-dimensional mixed indexes, so as to better adapt to the scaling requirements of heterogeneous computing tasks in various scenarios.

In addition, the GPU instance expansion in the task processing method provided in the present specification adopts a more aggressive strategy to ensure the service performance of a user function, while the GPU instance reduction adopts a more lazy strategy to ensure the cost of a user function. An aggressive coefficient and a lazy coefficient will take effect when the aggregate utilization of all GPU instances of the function is higher than a user configuration in FIG. 5.

The task processing method provided in the present specification determines a corresponding target virtual node for a target task based on current status information of initial virtual nodes and task type information of the target task when the target task is received, and executes the target task through the target virtual node, thereby meeting a need to accurately determine the target virtual node for the target task.

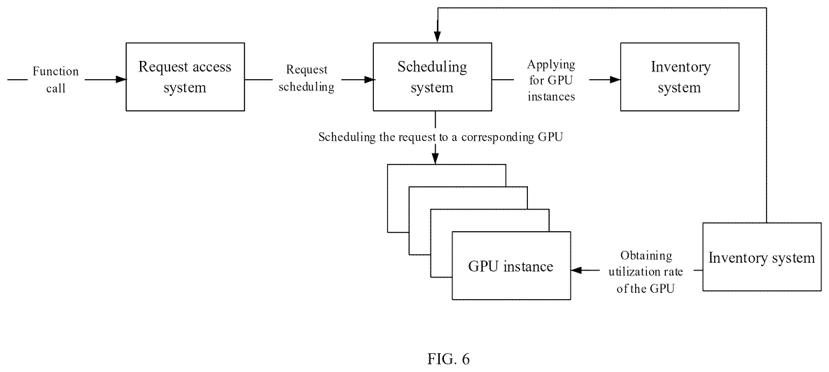

The following is combined with FIG. 6, taking an application of a task processing method provided in the present specification in an elastic scaling scenario based on a GPU utilization rate as an example to further illustrate the task processing method. FIG. 6 is a process flowchart of a task processing method provided by an embodiment of the present specification, and FIG. 6 provides a system framework for achieving elastic scaling based on a GPU utilization rate, where the system framework includes a request access system, a scheduling system, an inventory system, GPU instances, and a GPU monitor (GPU Monitor). The GPU monitor component (GPU Monitor) in the system framework is configured to obtain an internal hardware component utilization rate index of each GPU instance. It should be noted that the hardware components are different according to the different scenarios in which the task processing method provided in the present specification is applied. For example, in a case that the task processing method is applied to an audio and video production scenario, the hardware component may be a hardware encoding unit or a hardware decoding unit, in a case that the task processing method is applied to an AI production scenario, the hardware component may be a Cuda Core, etc. Accordingly, the hardware component utilization rate index include but are not limited to a hardware encoding utilization rate of the audio and video production scenario, a hardware decoding utilization rate of the audio and video production scenario, a Cuda Core utilization rate of the AI production scenario, a Tensor Core utilization rate of the AI production scenario, a NVLINK bandwidth utilization rate of the AI production scenario, a video memory utilization rate of all scenarios, etc.

Based on this, the GPU monitor periodically synchronizes the utilization rate of these GPU hardware component to the scheduling system. In a case that the user completes a Serverless service function writing and initiates a function call request to the request access system of a Serverless platform, the request access system schedules the request to the scheduling system through an access protocol. The Serverless scheduling system will elastically scale the GPU instance based on the GPU hardware utilization rate and the corresponding scheduling strategy. For example, the Serverless scheduling system will request or return GPU instance to the inventory system based on the GPU hardware utilization rate and the corresponding scheduling strategy, thereby achieving elastic the capacity expansion and reduction of GPU instances. It should be noted that the scheduling strategy can be set according to an actual application scenario, and the present specification does not make any specific limitations on this, such as the scheduling strategy shown in FIG. 4.

At the same time, after elastically expanding and reducing up the capacity of GPU instances, the Serverless scheduling system schedules the function call request of the user to different GPU instances to run the corresponding functions, the GPU instance is responsible for a specific execution of the function.

The task processing method provided in the embodiments of the present specification provides an elastic scaling control method based on different dimensional indexes of GPU in a Serverless scenario, so that heterogeneous computing tasks (audio and video production, AI production, graphics and image production) in different scenarios can set different elastic scaling indexes, thereby achieving an elastic scaling strategy that takes both performance and cost into consideration.

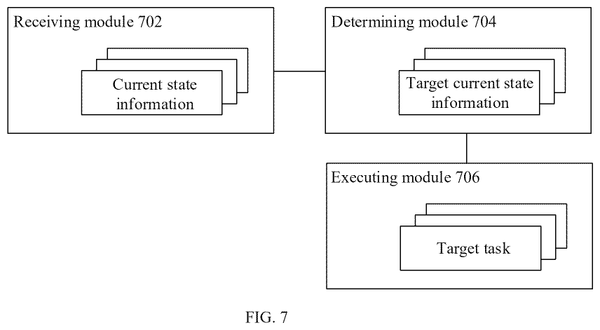

Corresponding to the above method embodiments, the present specification also provides a task processing apparatus embodiment. FIG. 7 is a structure schematic diagram of a task processing apparatus provided by an embodiment of the present specification.

As shown in FIG. 7, the apparatus includes:
a receiving module 702, configured to determine current state information of initial virtual nodes based on a target task received, where the current state information is determined based on a physical computing unit corresponding to the initial virtual nodes;
a determining module 704, configured to, based on task type information of the target task, determine candidate virtual nodes corresponding to the task type information from the initial virtual nodes; and
an executing module 706, configured to determine a corresponding target virtual node for the target task based on the current state information of the candidate virtual nodes, and execute the target task through the target virtual node.

In an implementation, the executing module 706 is further configured to:
based on the current state information of the candidate virtual nodes, select the target virtual node corresponding to the target task from the candidate virtual nodes.

In an implementation, the executing module 706 is further configured to:
based on the current state information of the candidate virtual nodes, add the corresponding target virtual node for the target task.

In an implementation, the task processing apparatus further includes a node processing module, configured to:
determine the current state information of the initial virtual nodes based on the physical computing unit corresponding to the initial virtual nodes; and
in a case that it is determined, based on the current state information, that the initial virtual nodes meet a preset node adding condition, add a new virtual node; or
in a case that it is determined, based on the current state information, that the initial virtual nodes meet a preset node deletion condition, delete an idle virtual node in the initial virtual nodes.

In an implementation, in the task processing apparatus, the physical computing unit is a GPU; accordingly, the receiving module 702 is further configured to:
based on the target task received, determine hardware components of the GPU and a current utilization rate of the hardware components; and
determine a target hardware component corresponding to the initial virtual nodes from the hardware components, and use the current utilization rate of the target hardware component as the current state information of the initial virtual nodes.

In an implementation, the task processing apparatus further includes a deleting module, configured to:
in a case that it is determined, based on the current utilization rate of the target hardware component, that the target task has been completed, delete the target virtual node.

In an implementation, the executing module 706 is further configured to:
determine a target computing ratio of the candidate virtual nodes based on the current state information of the candidate virtual nodes; and
in a case that the target calculation ratio is greater than or equal to a first ratio threshold, add the corresponding target virtual node for the target task.

In an implementation, the executing module 706 is further configured to:
generate a virtual node acquiring request based on the target task, and send the virtual node acquiring request to a virtual node providing module; and
receive a to-be-determined virtual node sent by the virtual node providing module based on the virtual node acquiring request, and determine the to-be-determined virtual node as the target virtual node corresponding to the target task,
In an implementation, the executing module 706 is further configured to:
determine a target computing ratio of the candidate virtual nodes based on the current state information of the candidate virtual nodes;
in a case that the target calculation ratio is less than a first ratio threshold, determine a minimum target calculation ratio from the target calculation ratio; and
based on the candidate virtual nodes corresponding to the minimum target calculation ratio, determine the target virtual node corresponding to the target task.

In an implementation, the node processing module is further configured to: determine a target computing ratio of the initial virtual nodes based on the current state information of the initial virtual nodes;
in a case that the target calculation ratio is greater than a node load threshold, determine that the initial virtual nodes meet the preset node adding condition; and
in a case that the initial virtual nodes meet the preset node adding condition, add the new virtual node based on a virtual node providing module.

In an implementation, the node processing module is further configured to: determine a target computing ratio of the initial virtual nodes based on the current state information of the initial virtual nodes;
in a case that the target computing ratio is less than a node idle threshold, determine that the initial virtual nodes meet the preset node deletion condition; and
in a case that the initial virtual nodes meet the preset node deletion condition, delete the idle virtual node in the initial virtual nodes.

In an implementation, the receiving module 702 is further configured to: based on the target task received, determine physical computing subunits in the physical computing unit and current operation information of the physical computing subunits;
determine a target physical computing subunit corresponding to the initial virtual nodes from the physical computing subunits; and
use the current operation information of the target physical computing subunit as the current state information of the initial virtual nodes.

In an implementation, the task processing apparatus further includes an information receiving module, configured to;
receive the current operation information of the physical computing subunits in the physical computing unit sent by an information collection module, where the information collection module is a module configured to monitor the current operation information of the physical computing subunits in the physical computing unit.

The task processing apparatus provided in the present specification determines a corresponding target virtual node for a target task based on current status information of initial virtual nodes and task type information of the target task when the target task is received, and executes the target task through the target virtual node, thereby meeting a need to accurately determine the target virtual node for the target task.

The above is a schematic scheme of a task processing apparatus of the present embodiment. It should be noted that the technical solution of the task processing apparatus belongs to a same concept as the technical solution of the task processing method described above, and the details not described in detail in the technical solution of the task processing apparatus can be referred to the description of the technical solution of the task processing method described above.

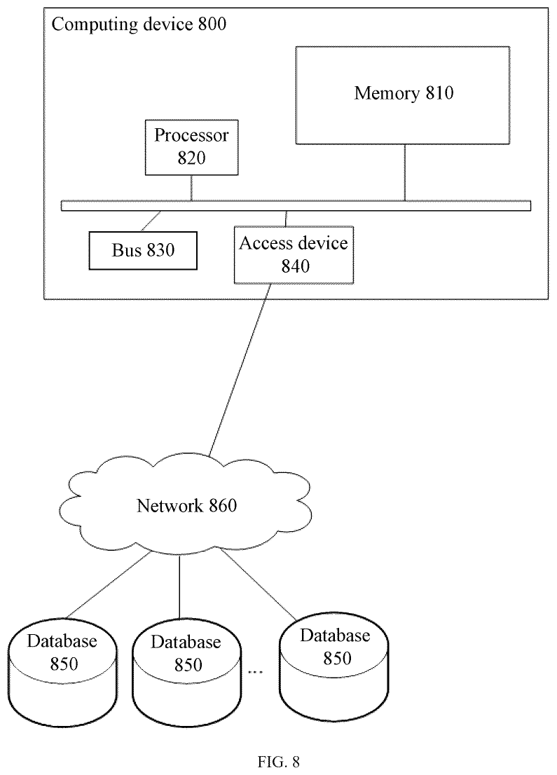

FIG. 8 is a structure block diagram of a computing device provided by an embodiment of the present specification. Components of the computing device 800 include, but are not limited to, a memory 810 and a processor 820.

The processor 820 is connected to the memory 810 via a bus 830, and a database 850 is configured to store data.

The computing device 800 also includes an access device 840 that enables the computing device 800 to communicate via one or more networks 860. Examples of these networks include a Public Switched Telephone Network (PSTN), a Local Area Network (LAN), a Wide Area Network (WAN), a Personal Area Network (PAN), or a combination of communication networks such as an Internet. The access device 840 may include one or more of any type of network interface (e.g., a network interface card (NIC)) whether wired or wireless, such as an IEEE802.11 wireless local area network (WLAN) wireless interface, a Worldwide Interoperability for Microwave Access (Wi-MAX) interface, an Ethernet interface, a Universal Serial Bus (USB) interface, a cellular network interface, a Bluetooth interface, a Near Field Communication (NFC) interface, and the like.

In one embodiment of the present specification, the above components of the computing device 800 and other components not shown in FIG. 8 may also be connected to each other, for example, through a bus. It should be understood that the computing device structure block diagram shown in FIG. 8 is for illustrative purpose only and is not intended to limit a scope of the present specification. Those skilled in the art can add or replace other components as needed.

The computing device 800 may be any type of stationary or mobile computing device, including a mobile computer or mobile computing device (e.g., a tablet computer, a personal digital assistant, a laptop computer, a notebook computer, a netbook computer, etc.), a mobile phone (e.g., a smartphone), a wearable computing device (e.g., a smart watch, smart glasses, etc.), or other type of mobile device, or a stationary computing device such as a desktop computer or PC. The computing device 800 may also be a mobile or stationary server.

The processor 820 is configured to execute following computer-executable instructions, which, the computer-executable instructions are executed by the processor 820, the steps of the task processing method above are implemented.

The above is a schematic scheme of a computing device of the present embodiment. It should be noted that the technical solution of the computing device belongs to a same concept as the technical solution of the task processing method described above, and the details not described in detail in the technical solution of the computing device can be referred to the description of the technical solution of the task processing method described above.

An embodiment of the present specification further provides a computer-readable storage medium storing computer-executable instructions, when the computer-executable instructions are executed by a processor, the steps of the task processing method above are implemented.

The above is a schematic scheme of a computer-readable storage medium of the present embodiment. It should be noted that the technical solution of the storage medium belongs to a same concept as the technical solution of the task processing method described above, and the details not described in detail in the technical solution of the storage medium can be referred to the description of the technical solution of the task processing method described above.

An embodiment of the present specification further provides a computer program, when the computer program is executed in a computer, the computer is caused to execute the steps of the task processing method above are implemented.

The above is a schematic scheme of a computer program of the present embodiment. It should be noted that the technical solution of the computer program belongs to a same concept as the technical solution of the task processing method described above, and the details not described in detail in the technical solution of the computer program can be referred to the description of the technical solution of the task processing method described above.

Specific embodiments of the present specification are described above. Other embodiments are within a scope of the appended claims. In some cases, the actions or steps documented in the claims may be performed in a different order than in the embodiments and still achieve the desired results. In addition, the processes depicted in the accompanying drawings do not necessarily require the particular order or consecutive order shown to achieve the desired results. In some embodiments, multitasking and parallel processing is also possible or may be advantageous.

The computer instructions include computer program codes, which may be in source code form, virtual node code form, executable file, or some intermediate form. The computer-readable medium may include: any entity or device capable of carrying the computer program code, a recording medium, a USB flash drive, a mobile hard disk, a magnetic disk, an optical disk, a computer memory, a read-only memory (ROM), a random access memory (RAM), an electrical carrier signal, telecommunication signal and a software distribution medium, etc. It should be noted that the content contained in the computer-readable medium can be appropriately increased or decreased according to the requirements of legislation and patent practice in the jurisdiction. For example, in some jurisdictions, according to legislation and patent practice, computer-readable media does not include electrical carrier signals and telecommunication signals.

It should be noted that, for the sake of convenience of description, the aforementioned method embodiments are all expressed as a series of action combinations, but those skilled in the art should be aware that the embodiments of the present specification are not limited to the described order of actions, because according to the embodiments of the present specification, certain steps can be performed in other orders or simultaneously. Secondly, those skilled in the art should also be aware that the embodiments described in the specification are all preferred embodiments, and the actions and modules involved are not necessarily required by the embodiments of the present specification.

In the above embodiments, the description of each embodiment has its own emphasis. For parts that are not described in detail in a certain embodiment, reference can be made to the relevant descriptions of other embodiments.

The preferred embodiments of the present specification disclosed above are only used to help explain the present specification. The alternative embodiments do not describe all details exhaustively nor limit the present disclosure to the specific embodiments described. Obviously, many modifications and changes can be made based on the content of the embodiments of this specification. The present specification selects and specifically describes these embodiments in order to better explain the principles and practical applications of the embodiments of the present specification, so that those skilled in the relevant technical field can well understand and use this specification. The present description is limited only by the claims appended hereto along with their full scope and equivalents.

1. A task processing method, comprising:
determining current state information of initial virtual nodes based on a target task received, wherein the current state information is determined based on a physical computing unit corresponding to the initial virtual nodes;
based on task type information of the target task, determining candidate virtual nodes corresponding to the task type information from the initial virtual nodes; and
determining a corresponding target virtual node for the target task based on the current state information of the candidate virtual nodes, and executing the target task through the target virtual node.

2. The task processing method according to claim 1, wherein the determining the corresponding target virtual node for the target task based on the current state information of the candidate virtual nodes comprises:
based on the current state information of the candidate virtual nodes, selecting the target virtual node corresponding to the target task from the candidate virtual nodes.

3. The task processing method according to claim 1, wherein the determining the corresponding target virtual node for the target task based on the current state information of the candidate virtual nodes comprises:
based on the current state information of the candidate virtual nodes, adding the corresponding target virtual node for the target task.

4. The task processing method according to claim 1, further comprising:
determining the current state information of the initial virtual nodes based on the physical computing unit corresponding to the initial virtual nodes; and
in a case that it is determined, based on the current state information, that the initial virtual nodes meet a preset node adding condition, adding a new virtual node; or
in a case that it is determined, based on the current state information, that the initial virtual nodes meet a preset node deletion condition, deleting an idle virtual node in the initial virtual nodes.

5. The task processing method according to claim 1, wherein the physical computing unit is a graphics processing unit (GPU);
accordingly, the determining the current state information of the initial virtual nodes based on the target task received comprises:
based on the target task received, determining hardware components of the GPU and a current utilization rate of the hardware components; and
determining a target hardware component corresponding to the initial virtual nodes from the hardware components, and using the current utilization rate of the target hardware component as the current state information of the initial virtual nodes.

6. The task processing method according to claim 5, after the executing the target task through the target virtual node, further comprising:
in a case that it is determined, based on the current utilization rate of the target hardware component, that the target task has been completed, deleting the target virtual node.

7. The task processing method according to claim 3, wherein the based on the current state information of the candidate virtual nodes, adding the corresponding target virtual node for the target task comprises:
determining a target computing ratio of the candidate virtual nodes based on the current state information of the candidate virtual nodes; and
in a case that the target calculation ratio is greater than or equal to a first ratio threshold, adding the corresponding target virtual node for the target task.

8. The task processing method according to claim 7, wherein the adding the corresponding target virtual node for the target task comprises:
generating a virtual node acquiring request based on the target task, and sending the virtual node acquiring request to a virtual node providing module; and
receiving a to-be-determined virtual node sent by the virtual node providing module based on the virtual node acquiring request, and determining the to-be-determined virtual node as the target virtual node corresponding to the target task.

9. The task processing method according to claim 2, wherein the based on the current state information of the candidate virtual nodes, selecting the target virtual node corresponding to the target task from the candidate virtual nodes comprises:
determining a target computing ratio of the candidate virtual nodes based on the current state information of the candidate virtual nodes;
in a case that the target calculation ratio is less than a first ratio threshold, determining a minimum target calculation ratio from the target calculation ratio; and
based on the candidate virtual nodes corresponding to the minimum target calculation ratio, determining the target virtual node corresponding to the target task.

10. The task processing method according to claim 4, wherein in the case that it is determined, based on the current state information, that the initial virtual nodes meet the preset node adding condition, adding the new virtual node comprises:
determining a target computing ratio of the initial virtual nodes based on the current state information of the initial virtual nodes;
in a case that the target calculation ratio is greater than a node load threshold, determining that the initial virtual nodes meet the preset node adding condition; and
in a case that the initial virtual nodes meet the preset node adding condition, adding the new virtual node based on a virtual node providing module.

11. The task processing method according to claim 4, wherein in the case that it is determined, based on the current state information, that the initial virtual nodes meet the preset node deletion condition, deleting the idle virtual node in the initial virtual nodes comprises:
determining a target computing ratio of the initial virtual nodes based on the current state information of the initial virtual nodes;
in a case that the target computing ratio is less than a node idle threshold, determining that the initial virtual nodes meet the preset node deletion condition; and
in a case that the initial virtual nodes meet the preset node deletion condition, deleting the idle virtual node in the initial virtual nodes.

12. The task processing method according to claim 1, wherein the determining the current state information of the initial virtual nodes based on the target task received comprises:
based on the target task received, determining physical computing subunits in the physical computing unit and current operation information of the physical computing subunits;
determining a target physical computing subunit corresponding to the initial virtual nodes from the physical computing subunits; and
using the current operation information of the target physical computing subunit as the current state information of the initial virtual nodes.

13. The task processing method according to claim 12, before the determining the current state information of the initial virtual nodes based on the target task received, further comprising:
receiving the current operation information of the physical computing subunits in the physical computing unit sent by an information collection module, wherein the information collection module is a module configured to monitor the current operation information of the physical computing subunits in the physical computing unit.

14. A computing device, comprising:
a memory and a processor;
the memory is configured to store computer-executable instructions; and the processor, when executing the computer-executable instructions, is configured to:
determine current state information of initial virtual nodes based on a target task received, wherein the c state information is determined based on a physical computing unit corresponding to the initial virtual nodes;
based on task type information of the target task, determine candidate virtual nodes corresponding to the task type information from the initial virtual nodes; and
determine a corresponding target virtual node for the target task based on the current state information of the candidate virtual nodes, and execute the target task through the target virtual node.

15. The computing device according to claim 14, wherein the processor is configured to:
based on the current state information of the candidate virtual nodes, select the target virtual node corresponding to the target task from the candidate virtual nodes.

16. The computing device according to claim 14, wherein the processor is configured to:
based on the current state information of the candidate virtual nodes, add the corresponding target virtual node for the target task.

17. The computing device according to claim 14, wherein the processor is configured to:
determine the current state information of the initial virtual nodes based on the physical computing unit corresponding to the initial virtual nodes; and
in a case that it is determined, based on the current state information, that the initial virtual nodes meet a preset node adding condition, add a new virtual node; or
in a case that it is determined, based on the current state information, that the initial virtual nodes meet a preset node deletion condition, delete an idle virtual node in the initial virtual nodes.

18. The computing device according to claim 14, wherein the physical computing unit is a graphics processing unit (GPU);
accordingly, the processor is configured to:
based on the target task received, determine hardware components of the GPU and a current utilization rate of the hardware components; and
determine a target hardware component corresponding to the initial virtual nodes from the hardware components, and use the current utilization rate of the target hardware component as the current state information of the initial virtual nodes.

19. The computing device according to claim 14, wherein the processor is configured to:
based on the target task received, determine physical computing subunits in the physical computing unit and current operation information of the physical computing subunits;
determine a target physical computing subunit corresponding to the initial virtual nodes from the physical computing subunits; and
use the current operation information of the target physical computing subunit as the current state information of the initial virtual nodes.

20. A non-transitory computer-readable storage medium on which a computer program is stored, wherein a processor, when executing the computer program, is configured to:
determine current state information of initial virtual nodes based on a target task received, wherein the current state information is determined based on a physical computing unit corresponding to the initial virtual nodes;
based on task type information of the target task, determine candidate virtual nodes corresponding to the task type information from the initial virtual nodes; and
determine a corresponding target virtual node for the target task based on the current state information of the candidate virtual nodes, and execute the target task through the target virtual node.
